(19) United States
(12) Patent Application Publication
(10) Pub. No.: US 2005/0250624 A1
(43) Pub. Date: Nov. 10, 2005

(54) Rehabilitation device

(76) Inventor: Yin-Fu Yu, Jiayi (TW)

Correspondence Address: NIKOLAI & MERSEREAU, P.A., 900 SECOND AVENUE SOUTH, SUITE 820, MINNEAPOLIS, MN, 55402, US

(21) Appl. No.: 10/841,309

(22) Filed: May 7, 2004

(51) Int. Cl. A61H 3/00; A47D 13/04; A63B 22/00; A47D 1/02

(52) U.S. Cl. 482/69

(57) ABSTRACT

A rehabilitation device includes a main frame, two support brackets each mounted on a first portion of the main frame, an armrest mounted on a mediate portion of the main frame, a top bracket mounted on a second portion of the main frame, and a damping unit pivotally mounted between the mediate portion of the main frame and the top bracket. Thus, the rehabilitation device is folded when not in use, thereby greatly reducing and saving the storage space.

### BACKGROUND OF THE INVENTION

1. Field of the Invention

The present invention relates to a rehabilitation device, and more particularly to a rehabilitation device that is foldable when not in use, thereby greatly reducing and saving the storage space.

2. Description of the Related Art

A conventional rehabilitation device is used to exercise the muscle, joint and skeleton of the user's wounded part, such as the wounded legs or the like, thereby achieving the rehabilitation effect. However, the conventional rehabilitation equipment has a fixed structure and cannot be folded when not in use, thereby occupying the storage space. In addition, the user needs to use the conventional rehabilitation equipment by aid of a professional person, thereby causing inconvenience to the user.

### SUMMARY OF THE INVENTION

The primary objective of the present invention is to provide a foldable rehabilitation device.

Another objective of the present invention is to provide a rehabilitation device that is folded when not in use, thereby greatly reducing and saving the storage space.

A further objective of the present invention is to provide a rehabilitation device, wherein all of the parts of the rehabilitation device are detachable, thereby facilitating storage, package and transportation of the rehabilitation device.

A further objective of the present invention is to provide a rehabilitation device that is assembled and dismantled easily and conveniently, thereby facilitating the user mounting the rehabilitation device.

In accordance with the present invention, there is provided a rehabilitation device, comprising:

a main frame;

two support brackets each mounted on a first portion of the main frame;

an armrest mounted on a mediate portion of the main frame;

a top bracket mounted on a second portion of the main frame; and

a damping unit pivotally mounted between the mediate portion of the main frame and the top bracket.

Further benefits and advantages of the present invention will become apparent after a careful reading of the detailed description with appropriate reference to the accompanying drawings.

### BRIEF DESCRIPTION OF THE DRAWINGS

FIG. 1 is a perspective view of a rehabilitation device in accordance with the preferred embodiment of the present invention;

FIG. 1A is an exploded perspective view of the rehabilitation device as shown in FIG. 1;

FIG. 2 is a side plan view of the rehabilitation device as shown in FIG. 1;

FIG. 3 is a schematic operational view of the rehabilitation device as shown in FIG. 2 in use;

FIG. 4 is a schematic operational view of the rehabilitation device as shown in FIG. 2 in use;

FIG. 5 is a schematic operational view of the rehabilitation device as shown in FIG. 2 in use;

FIG. 6 is a schematic operational view of the rehabilitation device as shown in FIG. 2 in use; and

FIG. 7 is a folded view of the rehabilitation device as shown in FIG. 1.

### DETAILED DESCRIPTION OF THE INVENTION

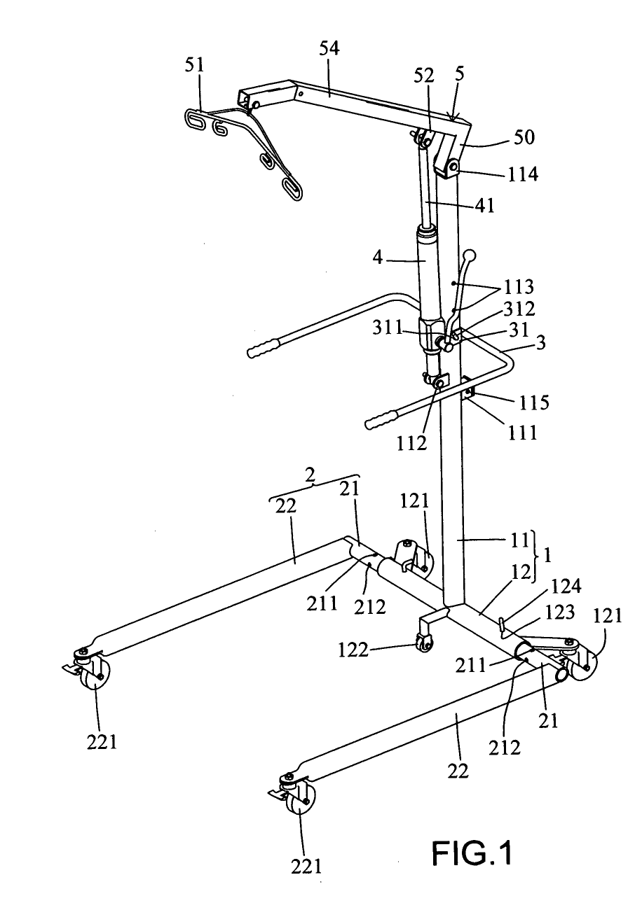

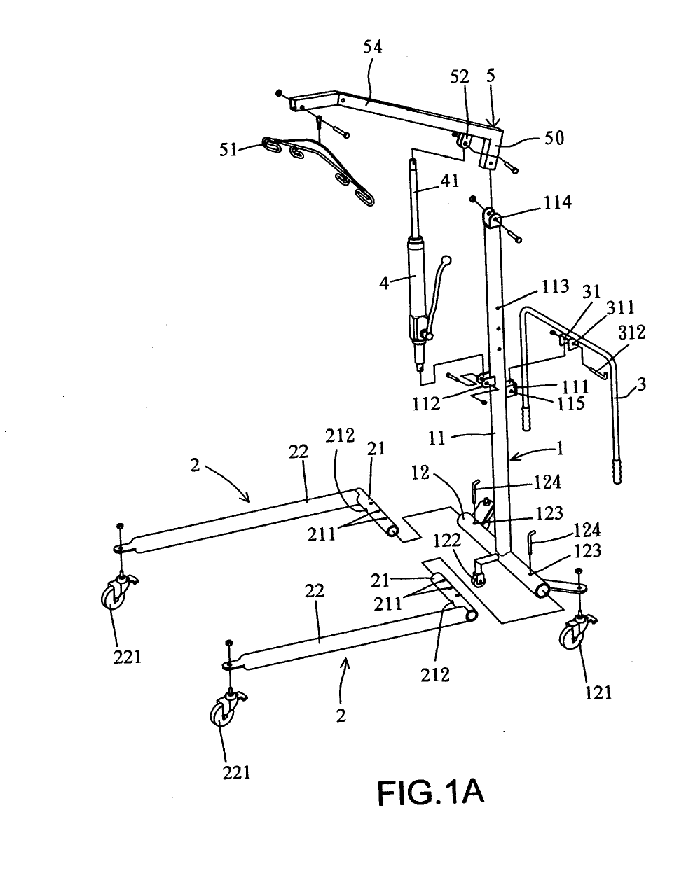

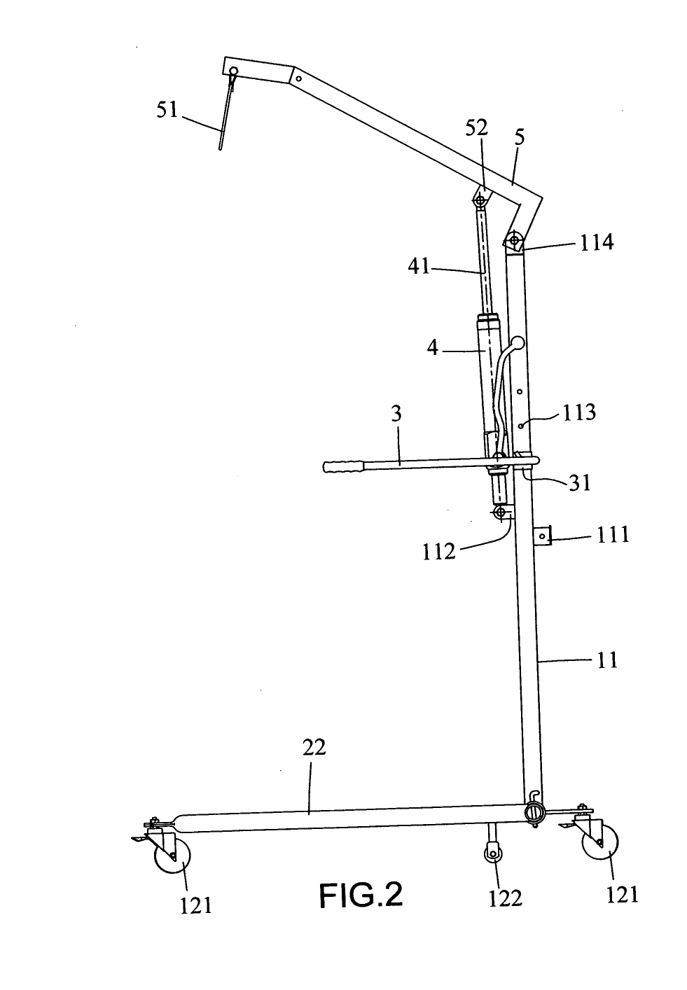

Referring to the drawings and initially to FIGS. 1, 1A and 2, a rehabilitation device in accordance with the preferred embodiment of the present invention comprises a main frame 1, two support brackets 2, an armrest 3, a top bracket 5, and a damping unit 4.

The main frame 1 is substantially T-shaped and includes a transverse section 12 and an upright section 11 mounted on the transverse section 12.

The transverse section 12 of the main frame 1 is a hollow tube and has two ends each provided with a movable wheel 121 and a mediate portion provided with a guide wheel 122. Each of the two ends of the transverse section 12 of the main frame 1 is formed with a pin hole 123.

The upright section 11 of the main frame 1 has a lower end mounted on a mediate portion of the transverse section 12 and an upper end provided with a pivot seat 114. The upright section 11 of the main frame 1 has a mediate portion provided with a protruding mounting block 111, two spaced pivot ears 112 located above the mounting block 111, and a plurality of adjusting holes 113 located above the pivot ears 112. The mounting block 111 of the upright section 11 of the main frame 1 is formed with a fixing hole 115.

Each of the two support brackets 2 is mounted on the main frame 1. Each of the two support brackets 2 is substantially L-shaped and includes a mounting section 21 adjustably mounted in the transverse section 12 of the main frame 1 and a support section 22 having a first end mounted on the mounting section 21 and a second end provided with a movable wheel 221. The mounting section 21 of each of the two support brackets 2 is formed with a plurality of adjusting holes 211 and a plurality of adjusting bores 212 located perpendicular to the adjusting holes 211.

The rehabilitation device further comprises two adjusting pins 124 each extended through the pin hole 123 of a respective end of the transverse section 12 of the main frame 1 and each detachably locked in either one of the adjusting holes 211 or the adjusting bores 212 of the mounting section 21 of a respective one of the two support brackets 2, so that each of the two support brackets 2 is adjustably mounted on the main frame 1.

The armrest 3 is mounted on the main frame 1. The armrest 3 is substantially U-shaped and has a mediate section provided with a substantially U-shaped fixing seat 31 secured on the upright section 11 of the main frame 1. The fixing seat 31 of the armrest 3 is formed with a pin hole 311.

The rehabilitation device further comprises a fixing pin 312 extended through the pin hole 311 of the fixing seat 31 of the armrest 3 and locked on the upright section 11 of the main frame 1, so that the fixing seat 31 of the armrest 3 is mounted on the upright section 11 of the main frame 1.

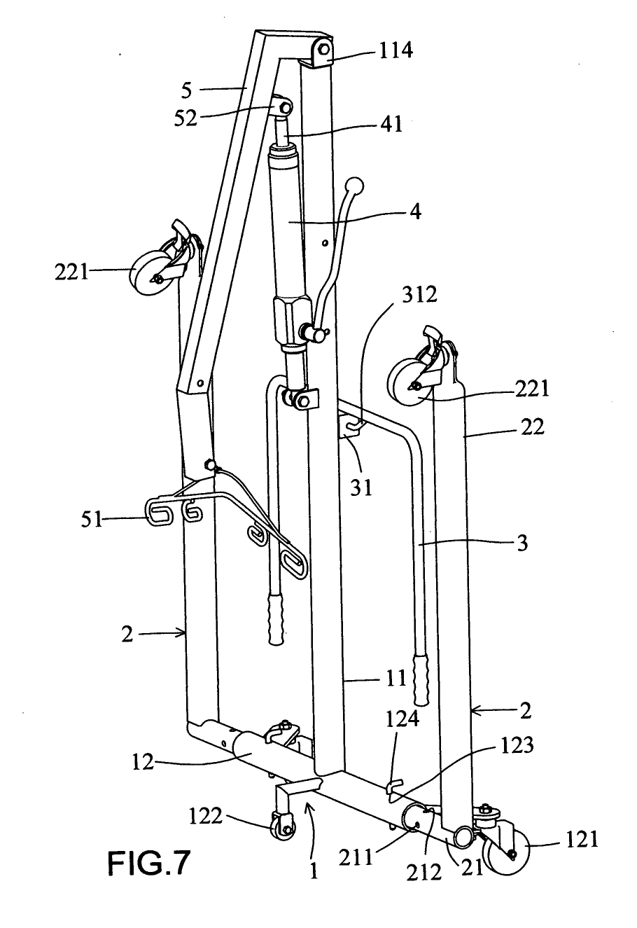

In assembly, when the fixing seat 31 of the armrest 3 is mounted on the mounting block 111 of the upright section 11, the fixing pin 312 is detachably locked in the fixing hole 115 of the mounting block 111, so that the fixing seat 31 of the armrest 3 is fixed on the mounting block 111 of the upright section 11 and the armrest 3 is parallel with the upright section 11 of the main frame 1 as shown in FIG. 7 so as to fold the armrest 3 when not in use. Alternatively, when the fixing seat 31 of the armrest 3 is directly mounted on the upright section 11 of the main frame 1, the fixing pin 312 is detachably locked in either one of the adjusting holes 113 of the upright section 11, so that the fixing seat 31 of the armrest 3 is adjustably fixed on the upright section 11 of the main frame 1 and the armrest 3 is perpendicular to the upright section 11 of the main frame 1 for use as shown in FIG. 1.

The top bracket 5 is pivotally mounted on the upright section 11 of the main frame 1. The top bracket 5 is substantially L-shaped and includes a first section 50 pivotally mounted on the pivot seat 114 of the upright section 11 of the main frame 1 and a second section 54 having a first end mounted on the first section 50 and a second end provided with a hanging rack 51. The first end of the second section 54 of the top bracket 5 is provided with two spaced pivot ears 52.

The damping unit 4 is pivotally mounted between the upright section 11 of the main frame 1 and the top bracket 5. The damping unit 4 has a first end pivotally mounted on the pivot ears 112 of the upright section 11 of the main frame 1 and a second end provided with a retractable bar 41 pivotally mounted on the pivot ears 52 of the top bracket 5.

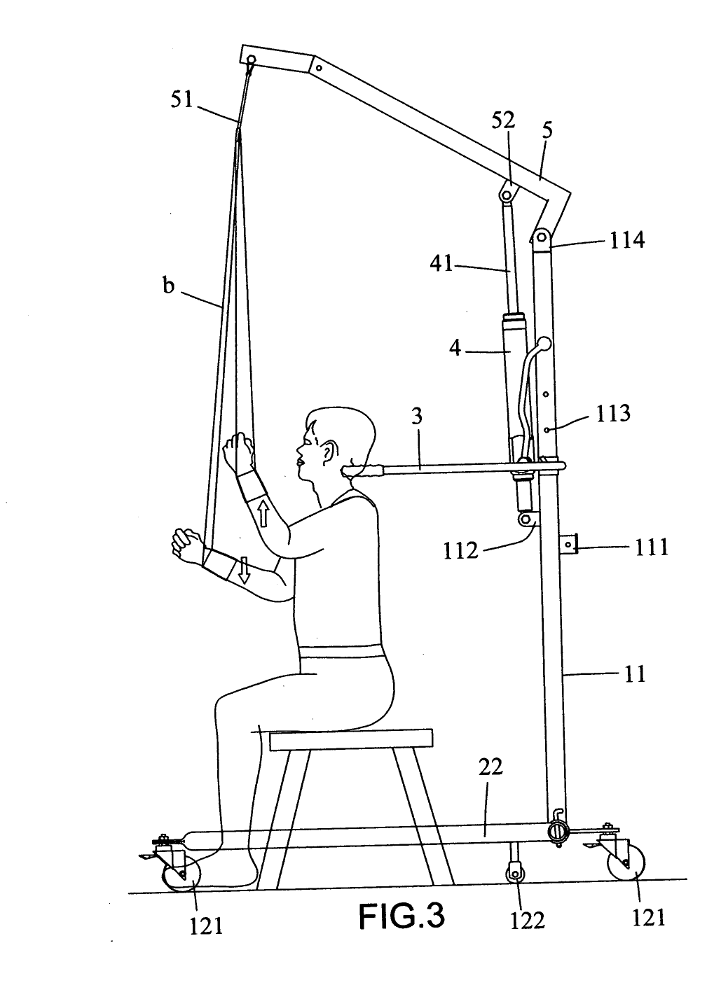

As shown in FIG. 3, a hanging strap “b” is mounted on the hanging rack 51 of the top bracket 5 and has two ends fastened on the hands of a user, so that the user can exercise his two hands.

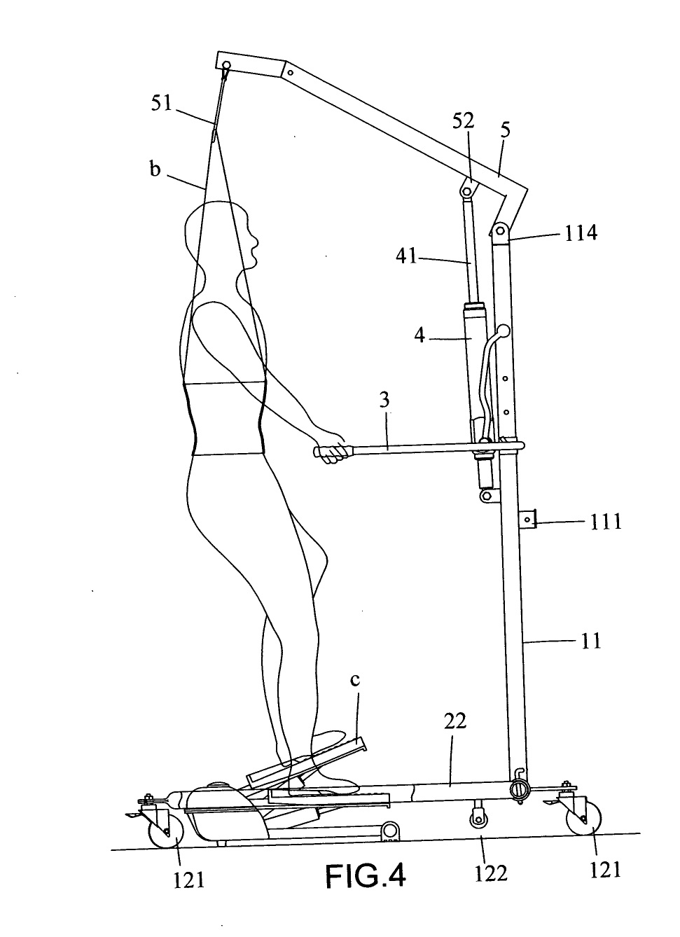

As shown in FIG. 4, the user steps on a mini stepper “c”, and the two ends of the hanging strap “b” are fastened on the waist of the user to support the user's body, so that the user can exercise his two legs.

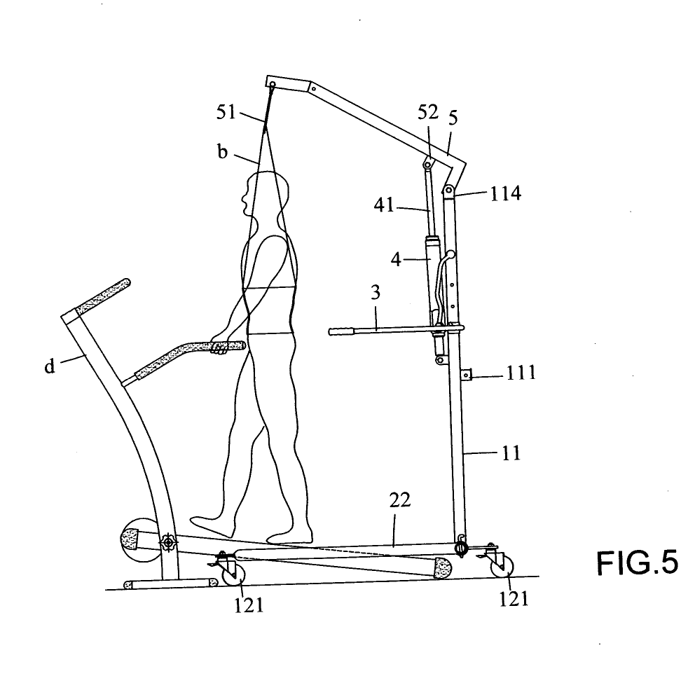

As shown in FIG. 5, the user steps on a tread mill “d”, and the two ends of the hanging strap “b” are fastened on the waist of the user to support the user's body, so that the user can exercise his two legs.

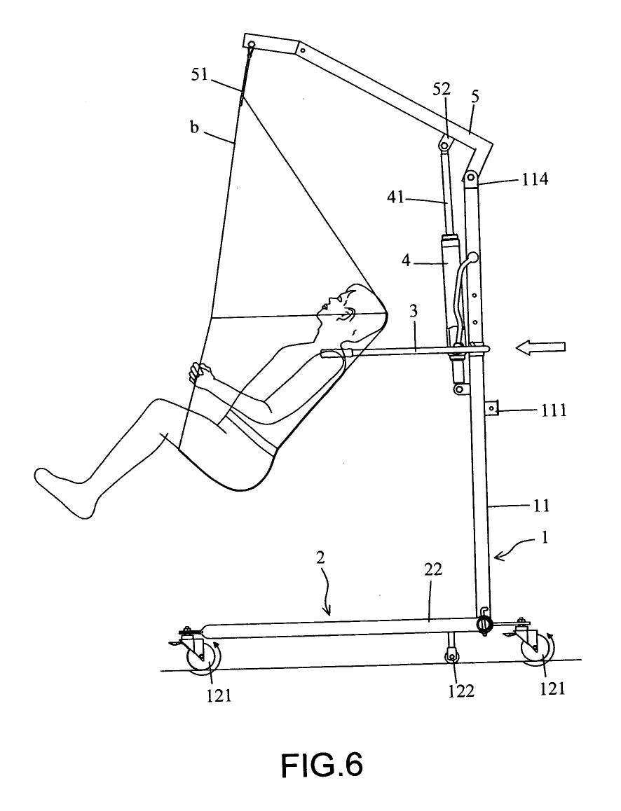

As shown in FIG. 6, the two ends of the hanging strap “b” are fastened around the user to support the user's body. Thus, the movable wheels 121 and the guide wheel 122 of the main frame 1 and the movable wheels 221 of the support brackets 2 are moved on the ground, so that the rehabilitation device functions as a wheeled vehicle so as to carry the user.

As shown in FIG. 7, each of the two adjusting pins 124 is detachably locked in either one of the adjusting bores 212 of the mounting section 21 of a respective one of the two support brackets 2, so that each of the two support brackets 2 is parallel with the upright section 11 of the main frame 1 so as to fold the two support brackets 2 when not in use. In addition, the fixing pin 312 is detachably locked in the fixing hole 115 of the mounting block 111, so that the fixing seat 31 of the armrest 3 is fixed on the mounting block 111 of the upright section 11 and the armrest 3 is parallel with the upright section 11 of the main frame 1 so as to fold the armrest 3 when not in use. In addition, the retractable bar 41 is retracted into the damping unit 4, so that the top bracket 5 is pivoted and parallel with the upright section 11 of the main frame 1 so as to fold the top bracket 5 when not in use.

Accordingly, the rehabilitation device is folded when not in use, thereby greatly reducing and saving the storage space of the rehabilitation device. In addition, all of the parts of the rehabilitation device are detachable, thereby facilitating storage, package and transportation of the rehabilitation device. Further, the rehabilitation device is assembled and dismantled easily and conveniently, thereby facilitating the user mounting the rehabilitation device.

Although the invention has been explained in relation to its preferred embodiment(s) as mentioned above, it is to be understood that many other possible modifications and variations can be made without departing from the scope of the present invention. It is, therefore, contemplated that the appended claim or claims will cover such modifications and variations that fall within the true scope of the invention.

1. A rehabilitation device, comprising:
a main frame;
two support brackets each mounted on a first portion of the main frame;
an armrest mounted on a mediate portion of the main frame;
a top bracket mounted on a second portion of the main frame; and
a damping unit pivotally mounted between the mediate portion of the main frame and the top bracket.

2. The rehabilitation device in accordance with claim 1, wherein the main frame is substantially T-shaped.

3. The rehabilitation device in accordance with claim 1, wherein each of the two support brackets is substantially L-shaped.

4. The rehabilitation device in accordance with claim 1, wherein the armrest is substantially U-shaped.

5. The rehabilitation device in accordance with claim 1, wherein the top bracket is substantially L-shaped.

6. The rehabilitation device in accordance with claim 1, wherein the main frame includes a transverse section and an upright section mounted on the transverse section.

7. The rehabilitation device in accordance with claim 6, wherein the transverse section of the main frame has two ends each provided with a movable wheel and a mediate portion provided with a guide wheel.

8. The rehabilitation device in accordance with claim 6, wherein the transverse section of the main frame has two ends each formed with a pin hole, each of the support brackets includes a mounting section mounted in the transverse section of the main frame and formed with a plurality of adjusting holes and a plurality of adjusting bores perpendicular to the adjusting holes, and the rehabilitation device further comprises two adjusting pins each extended through the pin hole of a respective end of the transverse section of the main frame and each detachably locked in either one of the adjusting holes or the adjusting bores of the mounting section of a respective one of the two support brackets, so that each of the support brackets is adjustably mounted on the main frame.

9. The rehabilitation device in accordance with claim 8, wherein the each of the two support brackets includes a support section having a first end mounted on the mounting section and a second end provided with a movable wheel.

10. The rehabilitation device in accordance with claim 6, wherein the upright section of the main frame has a mediate portion provided with a protruding mounting block formed with a fixing hole, the armrest has a mediate section provided with a fixing seat mounted on the mounting block of the upright section and formed with a pin hole, and the rehabilitation device further comprises a fixing pin extended through the pin hole of the fixing seat of the armrest and detachably locked in the fixing hole of the mounting block, so that the fixing seat of the armrest is fixed on the mounting block of the upright section and the armrest is parallel with the upright section of the main frame.

11. The rehabilitation device in accordance with claim 6, wherein the upright section of the main frame has a mediate portion formed with a plurality of adjusting holes, the armrest has a mediate section provided with a fixing seat mounted on the mounting block of the upright section and formed with a pin hole, and the rehabilitation device further comprises a fixing pin extended through the pin hole of the fixing seat of the armrest and detachably locked in either one of the adjusting holes of the upright section, so that the fixing seat of the armrest is adjustably fixed on the upright section of the main frame and the armrest is perpendicular to the upright section of the main frame.

12. The rehabilitation device in accordance with claim 6, wherein the upright section of the main frame has a mediate portion provided with two spaced pivot ears, and the damping unit has an end pivotally mounted on the pivot ears of the upright section of the main frame.

13. The rehabilitation device in accordance with claim 6, wherein the upright section of the main frame has a lower end mounted on a mediate portion of the transverse section and an upper end provided with a pivot seat, and the top bracket includes a first section pivotally mounted on the pivot seat of the upright section of the main frame and a second section having a first end mounted on the first section and a second end provided with a hanging rack.

14. The rehabilitation device in accordance with claim 13, wherein the first end of the second section of the top bracket is provided with two spaced pivot ears, and the damping unit has an end provided with a retractable bar pivotally mounted on the pivot ears of the top bracket.

15. The rehabilitation device in accordance with claim 8, wherein when each of the two adjusting pins is detachably locked in either one of the adjusting bores of the mounting section of a respective one of the two support brackets, each of the two support brackets is parallel with the upright section of the main frame.

16. The rehabilitation device in accordance with claim 8, wherein when each of the two adjusting pins is detachably locked in either one of the adjusting holes of the mounting section of a respective one of the two support brackets, each of the two support brackets is perpendicular to the upright section of the main frame.
